(19) United States
(12) Patent Application Publication
(10) Pub. No.: US 2016/0342282 A1
(43) Pub. Date: Nov. 24, 2016

(54) TOUCH-SENSING QUANTUM DOT LCD PANEL

(71) Applicant: FLATFROG LABORATORIES AB, Lund (SE)

(72) Inventor: Ola WASSVIK, Rossby (SE)

(21) Appl. No.: 15/111,980

(22) PCT Filed: Jan. 16, 2015
(86) PCT No.: PCT/SE2015/050041

§ 371 Date: Jul. 15, 2016

(30) Foreign Application Priority Data
Jan. 16, 2014 (SE) 1450037-5

(51) Int. Cl. G06F 3/042; F21V 8/00; G02F 1/1335; G02F 1/1368; G06F 3/041; G02F 1/1333

(52) U.S. Cl. CPC G06F 3/0421; G06F 3/0412; G02F 1/13338; G02F 1/133621; G02F 1/1368; G02B 6/005; G02F 1/133603; G06F 2203/04109; G02F 2202/36; G02F 2001/133614

(57) ABSTRACT

A touch-sensing display panel comprising: an LCD unit including a backlight unit and a plurality of image-forming pixel elements arranged in a central region; a light emitter emulated by passing light through a pixel element of a first selected portion of a peripheral region of the LCD unit, said emitter including a first quantum dot structure connected to receive excitation light from said backlight unit so as to emit light at longer wavelength than said excitation light; a planar light guide having a front surface forming a touch-sensing region and an opposite rear surface facing the LCD unit, said light guide being connected to receive emitter light for propagation therein through total internal reflection; a light detector connected to receive light from the light guide.

### CROSS-REFERENCE TO RELATED APPLICATIONS

This application claims the benefit and priority to and is a U.S. National Phase of PCT International Application Number PCT/SE2015/050041, filed on Jan. 16, 2015. This application claims the benefit and priority to Swedish patent application No. 1450037-5, filed 16 Jan. 2014. The disclosure of the above-referenced applications are hereby expressly incorporated by reference in their entirety.

### TECHNICAL FIELD

The present invention relates to touch sensing systems implemented with a display, and especially to liquid crystal display devices that employ quantum dot technology and offer optical touch sensitivity.

### BACKGROUND ART

Display devices with touch sensitivity are used today in a wide variety of applications such as touch pads in laptop computers, all-in-one computers, mobile phones and other hand-held devices, etc. It is often a desire to provide these electronic devices with a relatively large touch sensing display and still let the devices be small and thin.

There are numerous techniques for providing a display device with touch sensitivity, e.g. by adding layers of resistive wire grids or layers for capacitive touch-sensing or by integrating detectors in the display device. The major drawback of these techniques is that they reduce the optical quality of the display device, by reducing the amount of light emitted from the display or by reducing the number of active pixels of the display device.

U.S. Pat. No. 7,432,893 discloses a touch sensing system that uses FTIR (frustrated total internal reflection) to detect touching objects. Light emitted by a light source is coupled into a transparent light guide by a prism, then propagates inside the light guide by total internal reflection where after the transmitted light is received at an array of light detection points. The light may be disturbed (frustrated) by an object touching the light guide, whereby a decrease in transmitted light is sensed at certain light detection points. Providing a display device with this touch sensing system would add an undesired thickness and complexity to the display device.

WO2009/077962 also discloses a touch sensing system that uses FTIR to detect touching objects. Disclosed is a light guide with a tomograph having signal flow ports adjacent the light guide, the flow ports being arrayed around the border of the light guide. Light is emitted into the light guide by the flow ports and propagates inside the light guide by total internal reflection where after the transmitted light is detected at a plurality of flow ports. The light may be disturbed by an object touching the light guide. Providing a display device with this touch sensing system would add an undesired thickness and complexity to the display device.

A challenge connected to the art of optical touch-sensing systems is the provision of light emitters and detectors, and to the coupling of light in and out of the light guide. One advantageous way of implementing such a system is to employ a plurality of emitters and detectors dispersed along the perimeter of the display. However, including several emitters and detectors may entail increased requirements on alignment between these components, and on alignment with light coupling elements for connection to the light guide. A multitude of components will also add requirements on component reliability and assembly time.

### SUMMARY

It is an object of the invention to at least partly overcome one or more of the above-identified limitations of the prior art. More specifically, it is an object of the invention to provide a solution for optical touch-sensing display panels, which limits the demand placed on the system in relation to light emitters. Another object is to reduce the required thickness for providing touch sensitivity to a display device.

One or more of these objects, as well as further objects that may appear from the description below, are at least partly achieved by means of a touch-sensing display panel and an electronic device according to the independent claims, embodiments thereof being defined by the dependent claims.

A first aspect of the invention relates to a touch-sensing display panel, comprising an LCD unit including a backlight unit and a plurality of image-forming pixel elements arranged in a central region; a light emitter emulated by passing light through a pixel element of a first selected portion of a peripheral region of the LCD unit, said emitter including a first quantum dot structure connected to receive excitation light from said backlight unit so as to emit light at longer wavelength than said excitation light; a planar light guide having a front surface forming a touch-sensing region and an opposite rear surface facing the LCD unit, said light guide being connected to receive emitter light for propagation therein through total internal reflection; and a light detector connected to receive light from the light guide.

This means that an emitter for the purpose of providing optical touch sensitivity to a display is obtained by making use of the intrinsic features of an LCD unit, in combination with a quantum dot structure. Since no additional and separate emitters are needed, component cost may be lowered. Furthermore, no extra wiring or bonding is required, since the quantum dot structure is a passive device, which means that both assembly and driving may be very efficient. Various embodiments provide additional features, as will be outlined in the detailed description.

In one embodiment, said first quantum dot structure is configured to emit light in the IR range upon excitation by light in the visible range.

In one embodiment, said first quantum dot structure is arranged in a layer disposed between the backlight unit and the pixel elements in the peripheral region.

In one embodiment, said first quantum dot structure is arranged in a layer disposed between the rear surface of the planar light guide and the pixel elements in the peripheral region.

In one embodiment, said first quantum dot structure is arranged in a layer disposed at the front surface of the planar light guide in the peripheral region.

In one embodiment, the display panel comprises a second quantum dot structure configured to emit light in the visible region upon excitation by light from a backlight light source of said backlight unit.

In one embodiment, said second quantum dot structure is arranged in a layer disposed between the backlight unit and the pixel elements in the central region.

In one embodiment, the first quantum dot structure is arranged outwardly of the second quantum dot structure, at least partly in a common layer.

In one embodiment, the first quantum dot structure and the second quantum dot structure are formed as different portions of a common sheet.

In one embodiment, said second quantum dot structure is arranged in a layer disposed between the backlight unit and the pixel elements in the central region and in the peripheral region.

In one embodiment, said second quantum dot structure is configured to emit light in the green and red region upon excitation by blue light from said backlight light source.

In one embodiment, the display panel comprises an optical layer disposed at the rear surface of the light guide over at least the central region of the panel, wherein said optical layer is configured to reflect at least a part of the light from the emitter impinging thereon from within the light guide.

In one embodiment, said light guide has a first refractive index and the optical layer has a second refractive index which is lower than the first refractive index.

In one embodiment, said optical layer is an air gap.

In one embodiment, said optical layer is an optical coating, sheet or adhesive.

In one embodiment, an extension portion to the optical layer is disposed over the light emitter, said extension portion having a third refractive index which is higher than the second refractive index.

In one embodiment, said first quantum dot structure is provided in the peripheral region as an extension portion to said optical layer in the central region.

In one embodiment, the light emitter is coupled to emit light into the light guide, which light bypasses said optical layer.

In one embodiment, said light detector is coupled to receive light from the light guide, which light bypasses said optical layer.

In one embodiment, said LCD unit comprises a TFT electrode layer, to which said light detector is connected.

In one embodiment, a pixel element of a second selected portion of the peripheral region is configured to pass light to said light detector.

In one embodiment, the display panel comprises a plurality of emitters and/or detectors wherein a grid of propagation paths is defined across the touch-sensing region between pairs of light emitters and light detectors.

In one embodiment, the display panel comprises a cover frame over the peripheral region, covering said emitters.

A second aspect of the invention relates to an electronic device comprising the touch-sensing display panel of any preceding claim, and a controller connected to the LCD unit for causing the pixel elements of said first selected portions to open in a predetermined pattern.

In one embodiment, said controller is configured to cause the pixel elements to open in succession such that said emitters will act as flashed one by one.

### BRIEF DESCRIPTION OF DRAWINGS

Embodiments of the invention will now be described in more detail with reference to the accompanying schematic drawings.

FIG. 1 is a side view of an object in contact with a light transmissive light guide to illustrate the use of FTIR for touch sensing.

FIGS. 2A-2B show a top plan and a side view of an embodiment of the invention.

FIG. 3 is a top plan view of an embodiment with one activated emitter.

FIG. 4 is a side section view of a general embodiment of the invention.

FIG. 5 is a side section view of an embodiment with an alternative backlight unit configuration.

FIGS. 6-11 show respective side section views of various embodiments related to features of the emitter side of a display panel.

FIG. 12 show a side section view of an embodiment related to features of the detector side of a display panel.

FIG. 13 is a perspective view of a corner portion of an embodiment of a display panel.

FIG. 14 is a side section view of an embodiment related to features of light coupling in a display panel.

FIG. 15 shows a section view of an embodiment related to an electronic device incorporating a touch-sensing display panel.

### DETAILED DESCRIPTION OF EXAMPLE EMBODIMENTS

The present invention relates to the use of optical techniques, specifically FTIR, for providing touch sensitivity to a display apparatus. More specifically, the invention provides a truly integrated touch-sensing display panel 1, operating by means of FTIR in a liquid crystal display (LCD) device. Throughout the description the same reference numerals are used to identify corresponding elements.

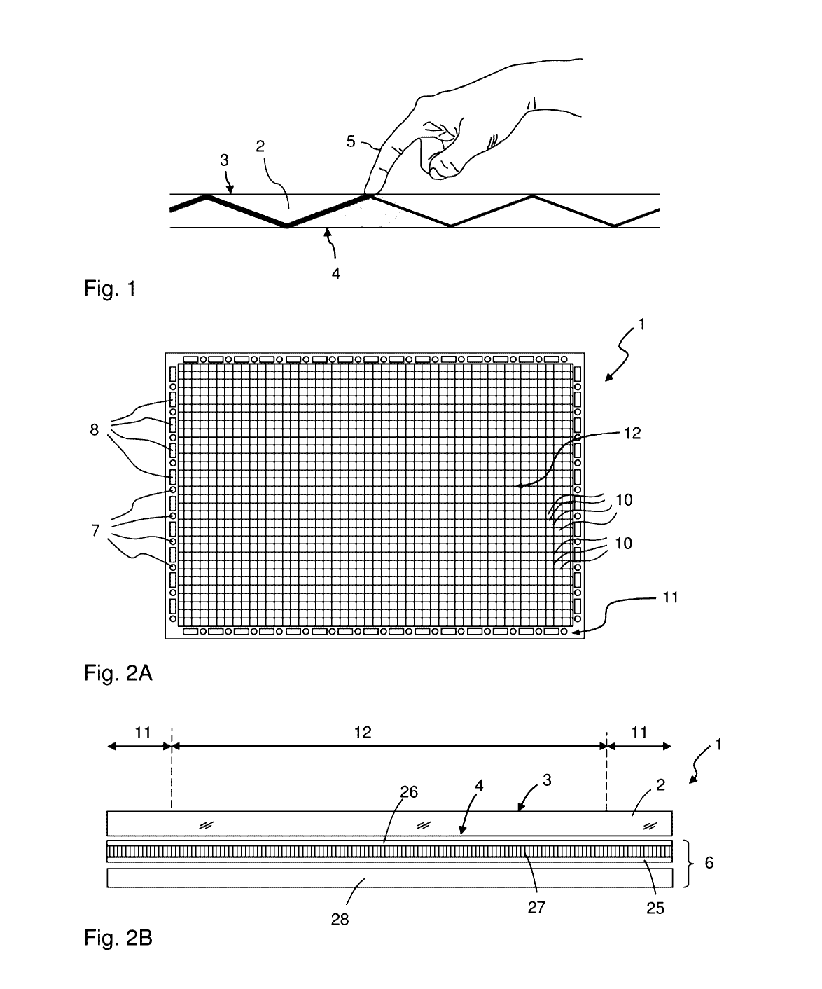

FIG. 1 illustrates the operating principle of a touch-sensing FTIR system. In the side view of FIG. 1, a beam of light is propagated by total internal reflection (TIR) inside a planar (two-dimensional) light guide 2. The light guide 2 comprises opposing surfaces 3, 4 which define a respective boundary surface of the light guide 2. Each boundary surface 3, 4 reflects light that impinges on the boundary surface from within the light guide 2 at an angle that exceeds the so-called critical angle, as is well-known to the skilled person. When an object 5 is brought sufficiently close to one of the boundary surfaces (here, the top surface 3), part of the beam may be scattered by the object 5, part of the beam may be absorbed by the object 5, and part of the beam may continue to propagate in the light guide by TIR in the incoming direction. Thus, when the object 5 touches the top surface 3, which forms a “touch surface”, the total internal reflection is frustrated and the energy of the transmitted light is decreased, as indicated by the thinned lines to the right of the object 5. This phenomenon is known as FTIR (Frustrated Total Internal Reflection) and a corresponding touch-sensing device may be referred to as an “FTIR system”.

Although not shown in FIG. 1, the FTIR system typically includes an arrangement of emitters and detectors, which are distributed along the peripheral region of the touch surface 3. Light from an emitter is introduced into the light guide 2 and propagates by TIR to one or more detectors. Each pair of an emitter and a detector defines a “detection line”, which corresponds to the propagation path from the emitter to the detector. Any object that touches the touch surface along the extent of the detection line will thus decrease or attenuate the amount of light received by the detector. The emitters and detectors are typically arranged to define a grid of intersecting detection lines on the touch surface, whereby each touching object is likely to cause an attenuation of several non-parallel detection lines.

The arrangement of detectors is electrically connected to a signal processor (cf. controller 41 of FIG. 15), which acquires and processes an output signal from the arrangement. The output signal is indicative of the power of transmitted light at each detector. The signal processor may be configured to process the output signal for extraction of touch data, such as a position (e.g. x, y coordinates), a shape, or an area of each touching object.

While FIG. 1 illustrates the working principle of FTIR touch as such, the invention relates to a touch-sensing display panel in which an FTIR touch-sensing mechanism is truly integrated with a display, as will be shown with reference to the subsequent drawings.

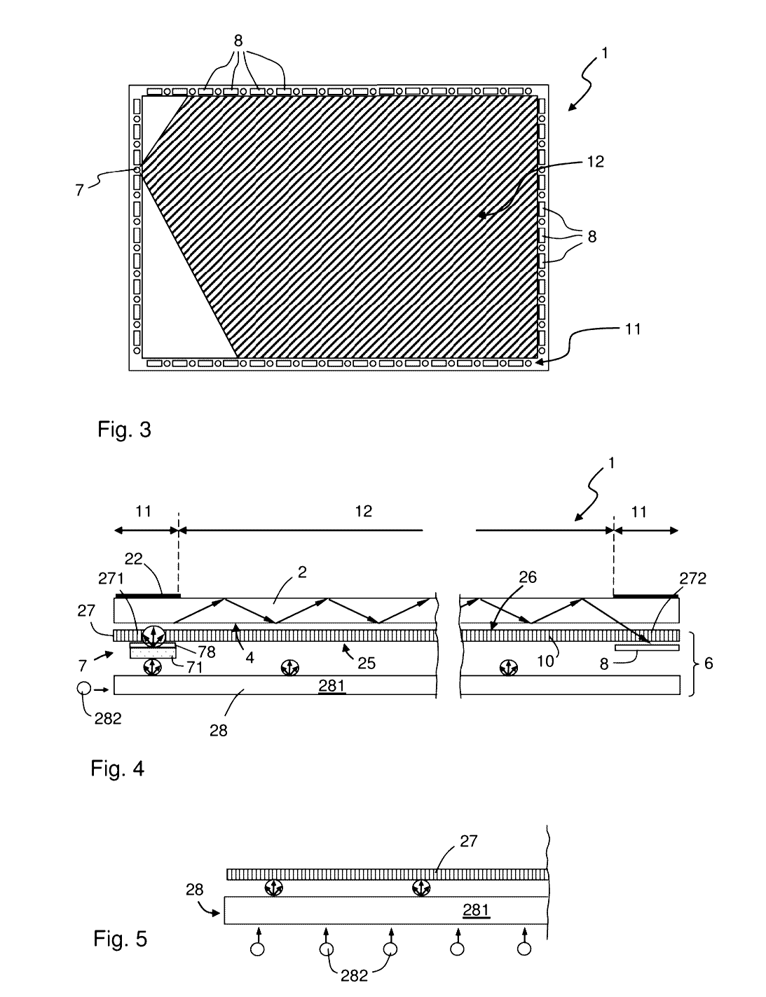

FIG. 2A is a top plan view and FIG. 2B is a side view of a touch-sensing display light guide 1 according to an embodiment of the invention, based on liquid crystal technology, preferably comprising a TFT-LCD (Thin Film Transistor Liquid Crystal Display). The touch-sensing display light guide 1 is implemented as a combination of a light transmissive light guide 2 that defines a front touch surface 3, and a dual-function display pixel matrix 6 which is configured to both display images through the front surface 3 and provide touch sensitivity to the front surface 3 via FTIR.

As seen in the plan view of FIG. 2A, a plurality of emitters 7 and detectors 8 (collectively referred to as “touch-sensor elements”) are arranged in interleaved fashion underneath a peripheral region 11 of the light guide 2. It should be noted, though, that interleaved arrangement is merely one example of positioning the emitters 7 and detectors 8. Another example may be to arrange emitters along two sides, and detectors along the other two sides, of the panel 1. In certain embodiments, the display panel 1 may comprise only one emitter 7 in combination with plural detectors 8, or only one detector 8 in conjunction with plural emitters 7. The display panel 1 may in fact comprise only one emitter 7 and one detector 8, for detecting the presence of a touching object 5 on the touch surface 3. In the drawings, for illustrative purposes only, emitters 7 and detectors 8 are represented by circles and rectangles, respectively. Furthermore, a center region 12 of the light guide 2 is aligned with a matrix of image-forming elements or picture elements (“pixels” or “pixel elements”) 10 that define a display area for displaying visual images in monochrome or color. Each emitter 7 is configured to generate a cone of light in any suitable wavelength region. In one embodiment, the emitter 7 generates light that is invisible to the human eye, preferably in the infrared (IR) region. Each detector 8 is configured to be responsive to the light emitted by emitters 7.

The section view of FIG. 2B more clearly illustrates the display unit 6 being based on liquid crystal technology. The LCD technology will not be discussed in detail, since it is a well-known technology, but the general layout will be dealt with in order to facilitate understanding of the invention. It should be noted, though, that FIG. 2B does not show any specific features related to the emitters 7 and detectors 8, other than the dashed indication of peripheral region 11. Various embodiments related to emitters 7 and detectors 8 will be dealt with further below.

The display unit 6 comprises a rear electrode layer 25, a front electrode layer 26 and an intermediate liquid crystal (LC) structure 27. The electrode layers 25, 26 are transparent and comprise respective polarizers. The rear electrode layer 25 comprises a pixel-defining electrode structure and may comprise a TFT active matrix for pixel selection, whereby the polarization of the LC structure 27 may be selectively controlled (addressed) at the location of each pixel. The front electrode layer 26 may be implemented as a common electrode and may also comprise color filters, as is known in the art. In the illustrated embodiment, the display unit 6 further comprises a backlight unit 28, which projects light for transmission through the electrode layers 25, 26 and the LC structure 27. A light transmissive light guide 2 is further arranged to define a front touch surface 3. In effect, the light guide 2 may be a sandwich structure including both color filters and polarizer, or simply be a planar cover lens, dependent on at which layer forms the rear surface 4 for reflection of the propagating light. The rear electrode layer 25 may be designed with detectors 8 (not shown) in its peripheral region 11. The detectors may e.g. be integrated as light-sensitive TFTs. Further details on TFT-LCDs and light-sensitive TFTs are e.g. found in WO2007/058924 and US2008/0074401, which are incorporated herein by reference. In an alternative embodiment, separate detectors 8 may be employed, positioned below the rear electrode layer 25.

Embodiments of the invention are based on the insight that the emitters 7 may be at least partly integrated into the display unit 6, and be formed by the same technology as used for producing images in the display area. Furthermore, the transparent display cover 2, which covers the pixel elements 10, is also used as a light guide. As such, various embodiments of the invention may be realized with virtually no addition of thickness or bulkiness at all. As used herein, an “integrated” emitter/detector 7, 8 is to be construed as an emitter/detector 7, 8 that is integrally formed on or in a structure, which typically is a composite LCD structure comprising a plurality of layers.

Compared to the prior art as described in the background section, embodiments of the invention make it possible to provide touch sensitivity to a display apparatus with very limited addition to the thickness of the display apparatus. Furthermore, the manufacturing cost may be reduced since there is no need for a separate mounting operation for attaching emitters 7 and detectors 8. As will be further exemplified below, the emitters/detectors 7, 8 may be at least partly formed from functional structures also present in the display unit for the operation of the pixels 10. This means that the emitters 7 and detectors 8 may be manufactured by the same or a similar process as the pixels 10, whereby the added manufacturing cost may be minimal. It is also to be noted that the number of emitters 7 and detectors 8 that need to be added is comparatively small compared to the number of pixels of a typical display apparatus. For example, a 3.5″ display may be provided with about 10-10² emitters and detectors, while the number of pixels is typically in the order of about 10⁵-10⁶. Still further, the touch sensitivity may be added without impairing the quality of images displayed in the display area, since the need to add touch-sensing layer(s) to the display area or integrate light detectors among the pixels within the display area is obviated.

Furthermore, by integrating the emitters/detectors 7, 8 at the peripheral region 11 of the display unit 6, it is possible to omit separate contacting of the emitters/detectors 7, 8. Instead, they may be contacted and electronically controlled in the same way as the pixels 10. For example, a data bus structure or an electronics backplane for supplying control signals to the pixels 10, to selectively control the light emitted by the pixels 10, may also be used to supply control signals to the individual emitters 7 and detectors 8 and/or to retrieve output signals from the individual detectors 8.

The light guide 2 may be included as a transparent substrate during manufacture of the display pixel matrix 6, e.g. as a backing for supporting the front electrode 26. Generally, the light guide 2 may be made of any material that transmits a sufficient amount of radiation in the relevant wavelength range to permit a sensible measurement of transmitted energy. Such material includes glass, poly(methyl methacrylate) (PMMA), polycarbonates (PC), PET (poly(ethylene terephthalate)) and TAC (Triallyl cyanurate). The light guide 2 may be flat or curved and may be of any shape, such as circular, elliptical or polygonal. It is possible that the light guide 2 is comprised of plural material layers, e.g. for the purpose of scratch-resistance, anti-fingerprint functionality, anti-reflection or other functional purpose. FIG. 2A indicates that the peripheral region 11 contains only emitters 7 and detectors 8, and thus is free of pixels 10. However, it is certainly possible to include pixels 10 also in the peripheral region 11, if desired.

FIG. 3 is a top plan view to further illustrate the operation of the touch-sensing display light guide 1. For reasons of clarity, the image-forming pixels 10 have been omitted. As shown, one emitter 7 is activated to emit an expanding beam of light. The emitted beam, or at least part thereof, is coupled into the light guide 2 such that it propagates by TIR across the touch surface 3, while expanding in the plane of the light guide 2 away from the emitter 7 (indicated by the hatched area). Such a beam is denoted a “fan beam” herein. Thus, each fan beam diverges from an entry or incoupling site, as seen on a top plan view. Downstream of the touch surface 3, the propagating light is coupled out of the light guide 2 and received by a subset of the detectors 8. As noted above, a detection line is formed between the emitter 7 and each of the detectors 8 that receive the fan beam. It is realized that a large number of detection lines may be generated by activating each of the emitters 7 and measuring the power of received light at the detectors 8 for each emitter 7. Depending on implementation, the emitters 7 may be activated in sequence or concurrently, e.g. by implementing the coding scheme disclosed in WO2010/064983.

Various embodiments will be described below, in which the emitters 7, configured to produce light for propagation in the light guide 2, are emulated by making use of the display panel 6 itself, more specifically the backlight unit 28 and LC pixels in the peripheral region 11, in combination with a quantum dot (also referred to herein as QD) structure 71.

As indicated by its name, a quantum dot is a nanocrystal made of semiconductor materials, small enough to display quantum mechanical properties. Typical dots may be made from binary alloys such as cadmium selenide, cadmium sulfide, indium arsenide, and indium phosphide, or made from ternary alloys such as cadmium selenide sulfide. Some quantum dots may also comprise small regions of one material buried in another material with a larger band gap, so-called core-shell structures, e.g. with cadmium selenide in the core and zinc sulfide in the shell. A quantum dot can contain as few as 100 to 100000 atoms within the quantum dot volume, with a diameter of 10 to 50 atoms. This corresponds to about 2 to 10 nanometers.

Characteristics of quantum dots have been known since the early 1980:s, and are well described in the art of nanophysics, and so are several known properties. One specific optical feature of quantum dots is the emission of photons under excitation, and the color of the emitted light. One photon absorbed by a quantum dot will yield luminescence, in terms of fluorescence, of one photon out. Due to the quantum confinement effect quantum dots of the same material, but with different sizes, can emit light of different colors. The larger the dot, the redder (lower energy) its fluorescence spectrum. Conversely, smaller dots emit bluer (higher energy) light. In other words, the bandgap energy that determines the energy (and hence color) of the fluorescent light is inversely proportional to the size of the quantum dot. The wavelength of the emitted light cannot be shorter than the wavelength of the absorbed light.

The ability to precisely control the size of a quantum dot enables manufacturers to determine the wavelength of the emission, which in turn determines the color of light the human eye perceives. The ability to control, or “tune” the emission from the quantum dot by changing its core size is called the “size quantisation effect”. The smaller the dot, the closer it is to the blue end of the spectrum, and the larger the dot, the closer to the red end.

It has been acknowledged that quantum dots are interesting for use in displays, because they emit light in very specific Gaussian distributions. This can result in a display that more accurately renders the colors that the human eye can perceive. Quantum dots also require very little power since they need not be color filtered. Traditionally, the backlight unit of a color LCD have been powered by fluorescent lamps or conventional white LEDs that are color filtered to produce red, green, and blue pixels. Improvements to the LCD technology have been suggested, which instead make use of a conventional blue-emitting LED as light source and converting part of the emitted light into pure green and red light by the appropriate quantum dots placed in front of the blue LED. This type of white light as backlight of an LCD unit allows for the better color gamut at lower cost than a RGB LED combination using three LEDs.

Different solutions for obtaining this effect have been suggested. QD Vision Inc. have developed a backlight solution that includes a thin transparent rod filled with a quantum dot composition. The rod is placed along one side of the backlight light guide, and is illuminated with blue light. The quantum dot composition will then shift, by its intrinsic fluorescence, part of the blue light to green and red light. Both unaffected blue light and shifted red and green light then gets coupled into the light guide of the backlight unit. The result is tri-chromatic (red, green and blue) white light.

Another way of making use of quantum dots in a backlight unit has been provided by Nanosys Inc together with 3M. Their suggestion is to replace the traditional diffuser film of a backlight unit with a film comprising quantum dots, a so-called Quantum Dot Enhancement Film, or QDEF. Blue LEDs are used to inject light into a backlight light guide, and part of the blue light is then shifted to emit green and red in the QDEF to provide tri-chromatic white light.

The present invention may be employed in a quantum dot type display, or in other types of LCDs, as will be described with reference to different embodiments below.

FIG. 4 shows an embodiment, in which the specific details and layers of the LCD unit 6 are largely left out, merely indicating the electrode layers 25, 26 at the faces of the LC layer 27. The LC structure 27 is schematically patterned to illustrate its pixel-divided structure. The drawing further indicates an emitter 7 included for injecting light into the light guide 2 at the peripheral region 11. Light from the emitter subsequently propagates in the light guide 2 across the touch-sensitive center region 12, and is coupled out at the peripheral region 11 to a detector 8. The emitter 7 is emulated by means of the LCD unit 6 and a first quantum dot (QD) structure 71, arranged in the peripheral region 11. More specifically, instead of making use of a separate light-emitting device, the emitter 7 is functionally operated by passing light through pixel elements in a first selected portion 271 of the peripheral region 11 of the LCD unit 6 and into the light guide 2. Furthermore, QD structure 71 is connected to receive excitation light from the backlight unit 28, typically in the visible wavelength range. In FIG. 4 this is illustrated by the encircled arrows from the backlight unit 28 towards the first QD structure 71. It should be noted that it is merely for the sake of simplicity that the first QD structure 71 is illustrated spaced apart from the backlight unit 28 and the LC structure 27. The first QD structure 71 may be provided as a sheet arranged face to face with the backlight unit 28. Furthermore, the first QD structure 71 may be arranged in mechanical abutment to the rear electrode layer 25 at the lower face of the LC structure 27. In one embodiment, the first QD structure 71 replaces an otherwise normally included diffuser layer of the backlight unit 28, in the peripheral region 11. In such an embodiment, a separate diffuser element (not shown in this drawing) may be included, sandwiched between the rear electrode layer 25 and the backlight light guide 281 in the central region 12. As an alternative, if no other functional element is provided in the central region 12, between the rear electrode 25 and the backlight unit 28, a transparent coupling layer (not shown) may be included, such as a coating of appropriate index of refraction, so as to obtain optical contact and even out the space between the backlight unit 28 and the rear electrode 25.

The backlight unit 28 is pumped with light from a light source 282. In this drawing, the backlight unit 28 is illustrated with the light source 282 being devised to pump light into a backlight light guide 281 from the side, a so-called edge-lit backlight unit 28. One or more individual light sources 282 may be incorporated, dispersed at different parts around the periphery of the panel 1. It may be noted that an alternative embodiment may be configured according to the principle of a full-array or matrix LED backlight unit 28, comprising many LEDs placed behind the LC layer 27. This is schematically illustrated in FIG. 5, in which most other details related to the panel 1 are left out for the sake of simplicity. It may also be noted that, although FIG. 5 only shows one row of backlight light sources 282, the backlight unit 28 preferably includes a two-dimensional array of light sources. Unless the type of backlight light source arrangement is specifically noted with respect to an embodiment described herein, any one of the edge-lit or matrix type backlight unit 28 may be used.

Reverting to FIG. 4, it will be understood that when excited, the first QD structure 71 will emit fluorescent light, of which at least a part will impinge on and be injected into the light guide 2, as indicated by the encircled arrows directed up from the first QD structure 71. A benefit of this design is that there is no need to provide any additional wiring or connectors to the emitter, which will in effect be a passive emitter 7, emitting light when pumped by light from the already present backlight unit 28 and by controlling a selected portion 271 of the already present LC structure 27 of the panel 6. In order to emulate different emitters 7 along the peripheral region 11, the LCD unit 6 is actively used to pass light through pixels at a number of selected first portions 271. The size of each such selected portion 271 may theoretically be only one pixel of the LCD unit 6, but more pixels may be included in each first portion 271 so as to pass a larger amount of light for each emulated emitter 7.

The material of the first QD structure 71 and the size of the QDs, will determine the spectral fluorescence of the first QD structure 71 when excited by light from the backlight unit 28. Preferably, the first QD structure 71 is configured to absorb mainly in a first wavelength range to produce emitter light in a second wavelength range, where the first wavelength range lies in the visible range. However, it is also possible to allow the backlight unit 28 to produce light in the UV or IR range, for excitation of the first QD structure 71. The second wavelength range preferably lies in the IR range, i.e. at wavelengths above the visible range. As an alternative, the second wavelength range may lie in the visible range. Functionally, FTIR in the visible range works just as well as in the IR range, although it may be cosmetically inferior. In any circumstance, emitted light from the first QD structure 71 will have longer wavelength than the excitation light.

There may be different ways of realizing the first QD structure 71. Different possible QD materials non-exhaustively include PbSe, PbS/CdS core/shell, InAs, InAs/InP/ZnSe core/shell/shell etc. Another example may be taken from the article “Near-infrared emitting CdTe0.5Se0.5/Cd0.5Zn0.5S quantum dots: synthesis and bright luminescence”, Nanoscale Research Letters 2012, 7:615, in which Yang et al. give examples related to synthesis of NIR-emitting QDs in the 700-900 nm range. They created hydrophobic core/shell QDs of the kind identified in the article title, with tunable photoluminescence between green and near-infrared, with a maximum peak wavelength of 735 nm with an average diameter of the QDs at 6.1 nm. It will thus be realized that numerous different examples of QD materials can be found in the art.

Furthermore, different means for suspending the QDs in the structure 71 may be used. In one example, the QDs may be suspended in a polymer film as a carrier material, such as in the Nanosys QDEF. Another example may be to provide QDs in an ink solution, which is printed on a substrate, which is then encapsulated. Such a configuration is suggested in “Tunable Infrared Emission From Printed Colloidal Quantum Dot/Polymer Composite Films”, published in Journal Of Display Technology, vol. 6, no. 3, March 2010, by Panzer et al. This article suggests to use QDs with a PbS core and a CdS shell, which are strongly absorptive across the visible wavelength region. A mixture of QDs and polyisobutylene (PIB) suspended in a mixture of hexane and octane was used as an ink to print the IR emissive layer on top of an indium tin oxide-coated substrate. A polymer matrix is used to encapsulate and isolate the QDs from one another, which they state allows for a higher photoluminescence quantum yield as compared to a film of QDs alone. Other ways of providing the first QD structure 71 may be to provide a QD solution in a thin transparent encapsulated vessel, similar to the QD Vision design, but preferably in a flat disc-like shape rather than in a narrow tube. In any situation, the skilled person would realize that there are many ways of putting the first QD structure into practice.

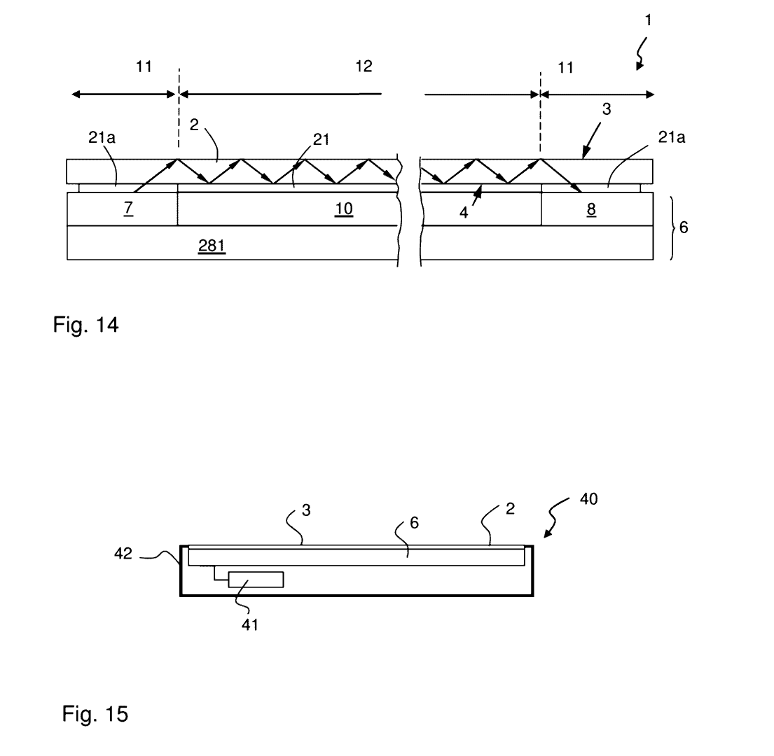

A quantum dot material is not a reflector, but a material that absorbs and emits light. As such, it does not repeat or reflect the angle of light received. Rather, each quantum dot acts as a new emitting dot, capable of emitting photons at various directions. In the embodiment of FIG. 4, the first QD structure 71 is provided under the selected portion 271 of the LC structure 27 at the peripheral region 11. Parts of the light emitted by the first QD structure 71 upon excitation from the backlight unit 28 will be coupled into the light guide 2 at an angle suitable for FTIR purposes, so as to subsequently propagate therein and be coupled out to a detector 8 at another portion of the peripheral region 11. In this sense, the first QD structure 71 may act as a diffuser in the peripheral region 11. Suitable angular ranges for FTIR purposes will in part be determined by Snell's law and the relation between indices of refraction between the light guide 2 and its neighboring optical layers facing the front surface 3 and rear surface 4. Different embodiments related to this effect will be described further below, with reference to FIG. 14.

The backlight unit 28 is preferably configured to emit white light. In one embodiment, the emitted light is a composition of three different spectral components, typically red (R), green (G), and blue (B). Such different spectral components may e.g. be obtained through separate LED light sources 282. Alternatively, one or more of those spectral components may be obtained by means of luminescence in a quantum dot material in the backlight unit. As yet another alternative, the backlight light source 282 may be configured to provide white light, such as a Cold Cathode Fluorescent Lamp (CCFL). It should be noted, though, that the present invention works just as well with a narrow band, monochromatic backlight. The first QD structure 71 comprises at least one composition of quantum dots, of a material and particle size so as to be configured to emit light at a certain wavelength upon absorption of excitation light within a predetermined wavelength from the backlight unit 28. In one embodiment, the material and particle size of the first QD structure 71 is responsive to emit Near Infrared (NIR) light, i.e. above 700 nm, responsive to absorption of blue light. Due to the nature of quantum dots, a certain composition of quantum dots, in terms of particle size and material, may absorb light throughout the visible wavelength range, but emit light at one peak wavelength, such as the CdTe0.5Se0.5/Cd0.5Zn0.5S QDs of the aforementioned Nanoscale Research Letters article.

Preferably, the detector 8 is tuned to sense light within the wavelength range of the emitter 7. The spectral sensitivity of the detector may be obtained by selecting a detector type, which is sensitive to the emitter wavelength. Furthermore, signal to noise ratio may be improved by providing a filter (not shown) between the light guide 2 and the detector 8, to efficiently block out light outside the peak luminescence wavelength of the first QD structure 71.

FIG. 4 further illustrates a cover frame 22, a feature which may be included in any one of the other described embodiments as well. The cover frame 22 is disposed to cover the peripheral region 11, and possibly also extend a portion into the central region 12. In FIG. 4, the cover frame 22 is illustrated as disposed at the front surface 4 of the light guide 2. However, there may be other possible configurations, as will be outlined. The cover frame 22 may fulfill different purposes. For one thing, the cover frame 22 may hide any structures in the peripheral region 11 from a user, particularly if only the central region 12 is used as an image display. For this purpose the cover frame 22 should be opaque to visible light. If only employed for this purpose, the cover frame 22 may alternatively be placed under the light guide 2, at its rear surface 3, or between different layers of the light guide 2. As another purpose, the cover frame 22 may be configured to block out ambient light from reaching the detectors 8. For this purpose, the cover frame 22 should be opaque to the operating wavelength of the touch-sensing system, i.e. the light detected by the detectors 8 from the emitters 7 to determine the occurrence of a touch. As mentioned, also the FTIR system may make use of visible light, but in a preferred embodiment NIR radiation is employed. If employed for this purpose, the cover frame 22 should be placed over the light guide 2, at its front surface 3, as in the embodiment of FIG. 4. As yet another purpose, the cover frame 22 may be configured to block out ambient light from reaching the QD structure 71, thereby minimizing the occurrence of fluorescent light being generated in the QD structure 71, caused by ambient light. For this purpose, the cover frame 22 should be opaque to light throughout the first wavelength range.

The cover frame 22 may e.g. be provided by means of a thin metal sheet. It may be provided as a separate element or form part of a housing or bracket for holding the display panel 1. In another embodiment, the cover frame 22 may be implemented as a coating or film, in one or more layers, on the front 3 or rear 4 surface. For example, an inner layer facing the front surface 3 may provide specular and possibly partly-diffuse reflectivity, and an outer layer may block ambient and/or visible light. In one embodiment, the cover frame 22 may comprise a chromium layer provided onto the top surface 3, to obtain a surface towards the panel light guide 2 which is at least partially specularly reflective to light in the emitter wavelength. In addition, the cover frame 22 may comprise an outer layer, which is substantially black to block visible light, by oxidizing the upper surface of the chromium layer. In other embodiments, other metals, with corresponding oxides, may be used, such as aluminum, silver etc. In yet other embodiments, the specularly reflecting lower layer may be provided by means of a metal, whereas an upper layer may be provided by means of paint, e.g. black paint. In any case, the cover frame 22 is preferably substantially flat, and should be as thin as possible while providing the desired benefits. In yet another embodiment, the cover frame may be disposed as an opaque frame layer between two different layers of the light guide 2.

In one embodiment, a wavelength-selective filter 78 may be provided over the QD structure 71, at the side of the QD structure 71 facing away from the backlight unit 28. In one variant, the filter 78 may be configured to be reflective to light in the first wavelength range, but transmissive to light in the second wavelength range. This way, light emanating from the backlight unit 28, passing through the QD structure 71 without absorption, may be reflected back to the QD structure 71, whereby a second chance of absorption is obtained. This way, a recycling effect is obtained for the pump wavelength, providing a possibility for an increased generation of light in the second wavelength range. The filter 78 may comprise a dielectric multilayer structure, configured to be substantially reflective to light in the first wavelength range, yet substantially transmissive to light in the second wavelength range. The reflectivity may depend on the angle of incidence, but should preferably be at least 50% at the normal angle of incidence within the first wavelength range, preferably at least 70% or even over 90%. In one embodiment, the filter 78 may also act as an ambient light filter for light throughout the first wavelength range coming in through the light guide 2, as otherwise described above as a function provided by means of the cover frame 22.

The filter 78 is only indicated in FIG. 4, but it should be understood that such a filter 78 may be applied in any one of the illustrated and described embodiments shown the other drawings.

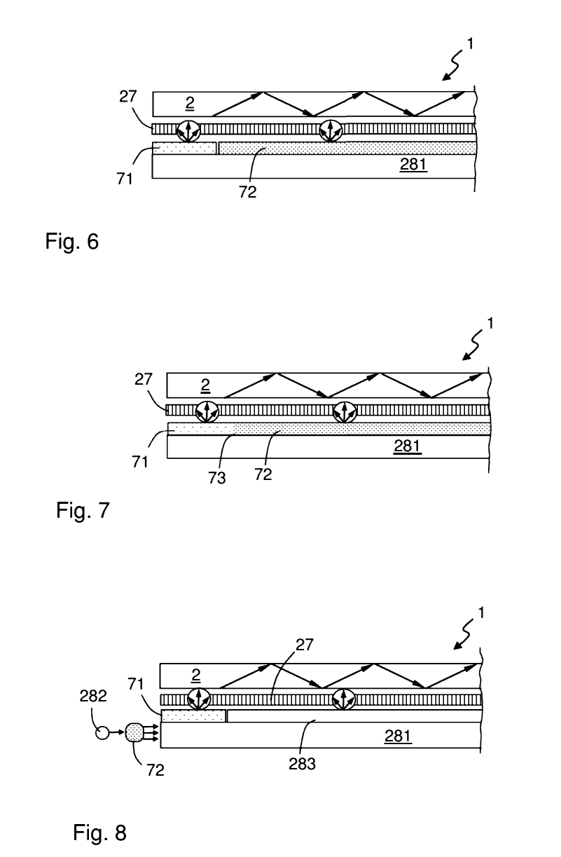

Variants of the embodiment of FIG. 4 will now be described with reference to FIGS. 6-11. Each one of these drawings show a cut-out portion of a touch-sensing display panel 1 in cross-section, illustrating an emitter side of the device. For the sake of simplicity, some of the details indicated in FIG. 4 are left out in these drawings, or not marked, but by turning to FIG. 4 it will be immediately clear which elements reference is made to below. It will also be clear from these drawings that the peripheral region 11, even though not specifically indicated, includes the part occupied by the first QD structure 71 to the left in these drawings, whereas the central region 12 includes the part of the drawing to the right of the peripheral region 11. Furthermore, it should also be understood that light emitted from the first QD structure 71 in the peripheral region will at least partly be coupled into the light guide 2, in which it will propagate through TR as indicated by the arrows.

FIG. 6 shows an embodiment with a mono-chromatic backlight unit 28, configured to emit blue light. This is preferably obtained by pumping a light guide 281 of the backlight unit 28 with blue light from a backlight light source 282 (not shown), as shown in FIG. 4 or 5. A first QD structure 71 is provided over the backlight light guide 281 in the peripheral region 11 of the panel, configured to receive blue excitation light from the backlight unit 28, so as to emit light at a longer wavelength, preferably in the infrared, such as in the NIR. In conjunction with pixel elements of a first selected portion 271 of the peripheral region 11 of the LCD unit, the first QD structure 71 functions to emulate the emitter 7, as already described with reference to FIG. 4. In addition, a second quantum dot structure 72 is provided. More specifically, in the embodiment of FIG. 6, the second quantum dot structure 72 is arranged in a layer disposed between the backlight light guide 281 and the pixel elements 10 in the central region 12, under the rear electrode layer 25. The second QD 72 structure is configured to emit light in the visible region upon excitation by light from the backlight light source 282. As such, the second QD structure 72 comprises a composition of at least two different types of quantum dots, differing in particle size and/or particle material, such that the second QD structure 72 will emit red and green light upon excitation by the blue backlight light source 282. The second electrode structure will furthermore be configured to be partly transmissive to blue light, such that the result will be tri-chromatic white light in the central region 12. The first QD structure 71 is arranged outwardly of the second QD structure 72, at least partly in a common layer, and the first 71 and second 72 QD structures are preferably equally thick to provide an even layered structure over the peripheral region 11 and the central region 12. The first 71 and second 72 QD structures are preferably sandwiched between the backlight light guide 281 and the rear electrode layer 25. The second QD structure may be realized by means of, or otherwise work as, a QDEF layer. The second QD structure 72 may also act as a diffuser of the backlight unit 28 for visible light in the central region 12.

FIG. 7 shows a variant of the embodiment of FIG. 6. A difference is that in this embodiment, the first QD structure 71 and the second QD structure 72 are formed as different portions of a common sheet 73. This common sheet 73 thus has different composition of quantum dots in the peripheral region 11 and in the central region 12, so as to emit light for FTIR purposes in the peripheral region 11 and visible light for display purposes in the central region 12. The first QD structure 71 may in this embodiment be configured only at discrete portions along the peripheral region 11, under the first selected portions 271 of the LCD unit, and at other parts of the common sheet 73, in the peripheral region 11, the composition of the second QD structure 72 may be provided.

FIG. 8 shows yet another embodiment, in which the first QD structure 71 is arranged in a layer between the LC structure 27 and the backlight light guide 281 in the peripheral region 11, like in the preceding embodiments. In this embodiment, though, the second QD structure 72 is configured between the light source 282 and the light guide 281 of the backlight unit 28. Preferably, the second QD structure comprises a composition of at least two different types of quantum dots, differing in particle size and/or particle material, such that the QD composition of the second QD structure 72 will emit red and green light upon excitation by the blue backlight light source 282. The second QD structure 72 will furthermore be configured to be partly transmissive to blue light, such that the result will be tri-chromatic white light, injected into the backlight light guide 281. The second QD structure 72 may be realized by means of, or otherwise work as, a transparent QD-containing tube as provided by QD Vision. The first QD structure 71 is provided as a layer attached over the backlight light guide 281, in the peripheral region 11, and is thus subjected to tri-chromatic light. As outlined with respect to FIG. 4, the quantum dots of the first QD structure 71 may be configured to emit light in a predetermined longer wavelength, upon excitation from all spectral components of the light from the backlight, or only responsive to emit light upon excitation of one of the RGB components of the tri-chromatic light. The backlight unit 28 may further comprise a diffuser 283, configured to spread the tri-chromatic light emitted from the backlight unit 28 at least throughout the central region 12. In a preferred version of this embodiment, the diffuser 283 is disposed adjacent to and inwardly of the first QD structure 71, as shown in FIG. 8, and not over the peripheral region at all. The diffuser 283 and the first QD structure 71 may be of substantially equal thickness, so as to provide an even layered structure over the peripheral region 11 and the central region 12, or otherwise additional coating may be provided to even out any difference in height at the peripheral region 11 and the central region 12. As an alternative solution, the first QD structure 71 and the diffuser 283 may be configured as different portions of a common sheet.

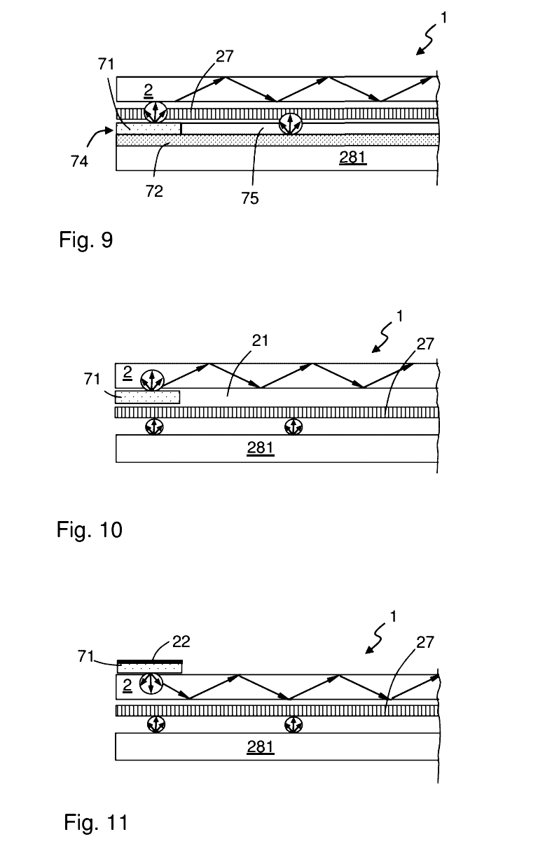

FIG. 9 shows an embodiment, also comprising a first QD structure 71 and a second QS structure 72. In this variant, though, both the first QD structure 71 and the second QS structure 72 are provided in layers, but on top of each other. A backlight unit 28 includes a light guide 281, and a backlight light source 282 (not shown) configured to pump blue light into the light guide 281, as shown in FIG. 4 or 5. The second quantum dot structure 72 is arranged in a layer disposed between the backlight light guide 281 and the rear electrode layer 25. The second QD structure 72 preferably extends under both the central region 12 and the peripheral region 11, and is configured to emit light in the visible region upon excitation by light from the backlight light source 282. As such, the second QD structure 72 comprises a composition of at least two different types of quantum dots, differing in particle size and/or particle material, such that the second QD structure 72 will emit red and green light upon excitation by the blue backlight light source 282. The second electrode structure will furthermore be configured to be partly transmissive to blue light, such that the result will be tri-chromatic white light, emitted from the second QD structure 72. As in the embodiment of FIG. 6, the second QD structure 72 may be realized by means of, or otherwise work as, a QDEF layer. The second QD structure 72 may also act as a diffuser of the backlight unit 28 for visible light in the central region 12.The first QD structure 71 comprises a composition of at least one type of quantum dots, with respect to particle size and/or particle material, such that the first QD structure 71 will emit light in the IR, preferably in the NIR, upon excitation by at least one of the spectral components of the tri-chromatic light from or through the second QD structure 72, as discussed with reference to FIG. 4.

Since the first QD structure 71 is disposed at the peripheral region 11 but not at the central region 12, a height gap could result between these two regions. In one embodiment, this situation is avoided by allowing the first QD structure 71 to form a peripheral part of a sheet 74, covering also the central region 12. However, a central part 75 of that sheet 74, covering the central region 12, will not include the first QD structure 71. Preferably, the central part 75 is highly transmissive to visible light. In a variant of this embodiment, the first QD structure 71 and the central part 75 do not form part of a common sheet. Rather, the central part 75 is made up of a separate sheet, optical adhesive or coating 75, applied over the central region 12 so as to accommodate for the height added by the first 71 QD structure.

FIG. 10 shows another variant of the general embodiment of FIG. 4, in which the first QD structure 71 is disposed over the front electrode layer 26 of the display unit 6. In this embodiment, the backlight unit 28 may be configured in accordance with any one of the previously described embodiments. In other words, the backlight unit 28 may be configured to emit white light throughout the central region 12 and the peripheral region 11, or only in the central region 12. Nevertheless, the backlight unit 28 is configured to emit light in the visible region in the peripheral region 11, which light may be monochromatic, e.g. blue, or include two or more colors. The backlight unit 28 may or may not comprise a second QD structure to generate the visible light emitted in the central region 12 and/or in the peripheral region 11.

In this embodiment, the first quantum dot structure 71 is arranged in a layer disposed between the rear surface 4 of the planar light guide 2 and the pixel elements of the LC structure 27 in the peripheral region 11. As for the general embodiment of FIG. 4, different emitters 7 along the peripheral region 11 of the LCD unit 6 may be emulated by actively controlling pixels at a number of selected first portions 271 of the LC structure 27 to pass light. However, in this specific embodiment, the light passed through the selected first portions 271 of the LC structure 27 is visible light. Once passed through the LC structure 27, photons will impinge on and at least partly be absorbed in the first QD structure 71. The first QD structure 71 will then generate emitter light by fluorescence at a longer wavelength, such as in the NIR, which emitter light at least partly will be injected into the light guide 2.

A benefit of such an embodiment may be that it is easy to apply to an already present LCD unit 6, since it is not configured between the backlight unit 28 and the LC structure 27. This also means that it may be quicker to implement such an embodiment to an LCD factory assembly line. Another benefit may be that the first QD structure 71 may be applied in direct contact with the rear surface 4 of the light guide 2, which may improve the optical coupling between the first QD structure 71 and the light guide 2. Another benefit may be related to the gap resulting in the central region 12, which may act as, or accommodate for, an optical layer 21 underneath the light guide 2, as will be described in more detail further below with reference to FIG. 14.

FIG. 11 shows yet another variant of the general embodiment of FIG. 4, in which the first QD structure 71 is arranged in a layer disposed at the front surface 3 of the planar light guide 2 in the peripheral region 11. Also in this embodiment, the backlight unit 28 may configured in accordance with any one of the previously described embodiments, as outlined with respect to FIG. 10. Different emitters 7 along the peripheral region 11 of the LCD unit 6 may be emulated by actively controlling pixels at a number of selected first portions 271 of the LC structure 27 to pass visible light. At least part of the light passed through the first selected portions 271 of the LC structure 27 will pass through the light guide 2 and hit the front surface 3. At the front surface 3, light will impinge on and at least partly be absorbed in the first QD structure 71. The first QD structure 71 will then generate emitter light by fluorescence at a longer wavelength, such as in the NIR. The emitter light will then at least partly be injected into the light guide 2 through the front surface 3, for further propagation in the light guide 2.

This embodiment too may have the benefit of easy application to an already present LCD unit 6, since it is not configured between the backlight unit 28 and the LC structure 27. This also means that it may be quicker to implement such an embodiment to an LCD factory assembly line. Also, this embodiment may benefit from the fact that the first QD structure 71 may be applied in direct contact with the rear surface 4 of the light guide 2, which may improve the optical coupling between the first QD structure 71 and the light guide 2.

Again, it may be noted that any one of the embodiments of FIGS. 6-10 may also comprise a cover frame 22, even though it is left out for the sake of clarity. In the embodiment of FIG. 11, a cover frame 22 is shown, which is applied over the first QD structure 71. This cover frame 22 is preferably opaque to visible light and to the operating wavelength of the fluorescence light from the first QD structure 71. Also, the cover frame 22 may be specularly or diffusively reflective on its downwards-facing side, so as to assist in spreading light emitted from the first QD structure 71 within the light guide 2.

FIG. 12 shows an embodiment related to the detector side of the display panel. This may be seen as an alternative to the more general embodiment of FIG. 4. In this embodiment, a third QD structure 76 is included over pixel elements of second selected portions 272 of the peripheral region 11 of the LCD unit 6. The third QD structure 76 comprises a quantum dot composition configured to absorb light of the wavelength emitted by the first QD structure 71, and to emit fluorescence light at a longer wavelength. This longer wavelength preferably lies further up into the IR range. As an example, the light from the first QD structure 71 may be configured to emit light in the NIR, e.g. in the range of 750-1000 nm upon excitation with visible light, whereas the third QD structure may be configured to emit light in the range of 1-1.6 μm when excited by light in the NIR. When light, which has propagated through the light guide 2 from one or more emitters 7, hits the rear surface 4 where the third QD structure 76 is placed, the third QD structure 76 will absorb at least a part of that light, and emit the longer wavelength light through the pixel elements of the second selected portions 272, by means of which the longer wavelength light is passed to the light detectors 8.

Similar to the embodiments of FIGS. 10 and 11, a benefit of the embodiment of FIG. 12 may be that since the third QD structure 76 may be applied in direct contact with the rear surface 4 of the light guide 2, improved optical coupling between the third QD structure 76 and the light guide 2 may be obtained, for coupling light out to the detectors 8. Also, as noted with respect to FIG. 10, and as will be outlined, a benefit may be related to the gap 21 resulting in the central region 12, which may act as an optical layer underneath the light guide 2. In an alternative embodiment, the third QD structure 76 is instead provided at the front surface 3, corresponding to the emitter embodiment of FIG. 11. Furthermore, any one of the detector embodiments may be combined with any one of the emitter embodiments described with reference to FIGS. 4-11.

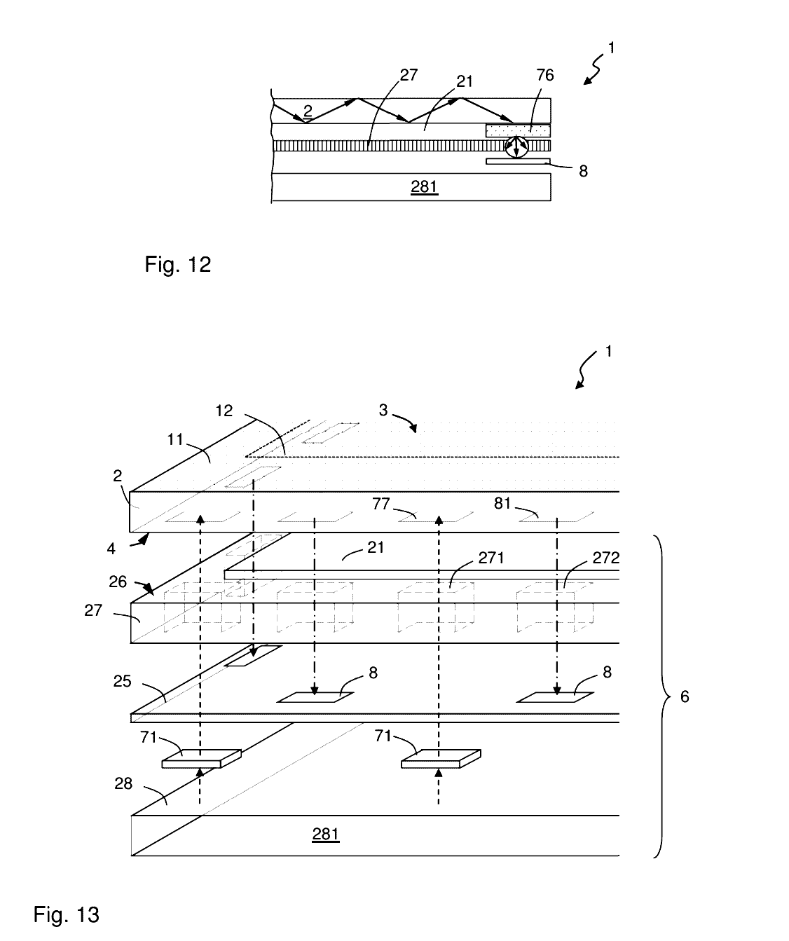

FIG. 13 shows an embodiment of the invention, corresponding to that of FIG. 4. The drawing shows a perspective view of a corner portion of a touch-sensing display panel 1, in which a number of elements have been vertically separated for the purpose of illustration only. Basically, the display panel 1 of this embodiment includes the LCD unit 6 and a light guide 2 which provides the touch-sensitive surface 3. At the bottom of the drawing, a backlight unit 28 is disposed, including a backlight light guide 281. Light is injected into the backlight light guide 281 from a light source 282 (not shown). The backlight unit 28 is configured to leak out light upwards through the display layers, throughout the two-dimensional extension of the display device 1, including the central region 12 and the peripheral region 11 indicated at the front surface 3. In addition to the backlight unit 28, the LCD unit 6 comprises an electrode 25 including a lower polarizer, a liquid crystal (LC) layer 27, and an upper electrode 26 (indicated at an upper surface of the LC layer 27) with an upper polarizer and color filters. The electrode 25 comprises a pixel-defining structure and may include a TFT active matrix. In operation together with the upper electrode 26, the electrode 25 is configured to define pixels in the intermediate LC layer 27. Also, the TFT active matrix connect to detectors 8, to read out sensed received light. Such detectors may e.g. be photo detectors, OLEDs or similar. This way, the LC layer 27 and the related electrodes 25, 26 form a pixel structure, including a plurality of image-forming pixel elements 10 (not shown) arranged in the central region 12, as well as pixel elements in the peripheral region 11. More specifically, first selected portions 271 of the pixel elements in the peripheral region 11 are used to emulate light emitters 7. In this drawing, this is indicated by the dashed vertical arrows through two such first selected portions 271. It should also be noted that the arrows are symbolic and that rather a cone of light will be led out in reality, as determined by the configuration of the backlight unit 28 and other components of the LCD unit 6.

While the backlight unit 28 is configured to provide visible light, a first QD structure 71 is connected to receive excitation light from the backlight unit 28, so as to emit light at longer wavelength than the excitation light. As already noted, the excitation light may be one or more components of visible light from the backlight unit 28, but also shorter or longer wavelengths. The light emitted by the first QD structure 71 may be in the infrared, e.g. in the NIR, and at least part of the light will be emitted towards incoupling region 77 of the light guide 2. The LC layer 27 is preferably driven by a controller 41 (not shown) using the electrodes 25, 26 according to a predetermined scheme such that the LC layer 27 is opened at portions 271 in a certain pattern, to pass light from the first QD structure 71. In one embodiment, portions 271 are opened one by one in succession, such that each portion 271 will serve as, or emulate, one emitter 7, which emitters 7 will act as flashed one by one. It should be noted that in variants of this embodiment the first QD structure may be placed between the upper electrode 26 and the light guide 2, or even over the light guide, as described with reference to FIGS. 10 and 11.

Once injected in the light guide 2, at least parts of the light will propagate by TIR in at least the front surface 3 to an outcoupling region 81 at the rear surface 4. Furthermore, the LC layer 27 is preferably driven by the controller 41 over the electrodes 25, 26 such that the LC layer 27 is held open, or intermittently flashed open, i.e. transmissive, at portions 272 over the detectors 8, below the outcoupling regions 81. This way, light coupled out from the light guide 2 is led to the detectors 8, as indicated by the vertical dash-dotted arrows. The incoupling 77 and outcoupling 81 regions may include diffusive and/or diffractive elements to direct light in or out of the light guide 2, as outlined further below. It may be noted that the size of the portions 271 and 272 of the LC layer 27 need not be equally large, even though the drawing indicates this. Also, each such portion 271 and 272 is preferably made up of a plurality of pixels formed by means of the TFT active matrix 25 and the LC layer 27. FIG. 13 further shows an optical layer 21, configured to cover at least the central region 12 at the lower surface 4 of the light guide 2. If the light guide 2 has a first refractive index (n₀), the optical layer 21 preferably has a second refractive index (n₁) which is lower than the first refractive index (n₀), if needed to assist or sustain light propagation by TIR in the light guide 2. This feature will be described in more detail with reference to FIG. 14. As will also be described to reference to FIG. 14, an optical layer 21a (not shown in FIG. 13) may be provided over the peripheral region 11, outwardly to the optical layer 21, as an extension portion of the optical layer 21.

FIG. 14 shows a schematic and simplified embodiment of the invention, indicating the light guide 2 and the LCD unit 6. Instead of showing the different elements of the LCD unit 6, this drawing indicates the image-forming pixel elements 10 in the central region 12, and the emitter 7 and detector 8. From the foregoing, though, it will be understood how these features are emulated and driven by means of the LCD unit 6. Reference to this drawing will be made for the purpose of describing the features of the optical layer 21, which may be incorporated in any one of the aforementioned embodiment. It may be understood that the purposive use of the emitter 7 and detector 8 on the one hand, and the image-forming pixel elements 10 on the other hand, are quite different. The image-forming pixels 10, i.e. the display pixels, are configured to shine light out from the display panel 1, preferably in a wide cone angle but most importantly straight up (in the drawing), which would normally represent the best viewing angle for an observer. The emitter 7, however, will only be useful if its light is captured within the light guide 2 to propagate with TIR towards the detector 8. As a consequence, the part of the light emanating from the emitter 7 that goes straight up will be lost. However, a good part of the light will impinge on the front surface 3, from the inside of the light guide 2, in a wide enough angle to be deflected by TIR.

One potential problem, though, is related to index matching at the rear surface 4 of the light guide 2. If not controlled, emitter light injected into the light guide 2 may, after a reflection in the front surface 3, escape downwards through the pixels 10. For this purpose, an optical layer 21 may be disposed between the rear surface 4 of the light guide 2 and the image-forming pixels 10. In one embodiment this optical layer 21 is made from a material which has a refractive index n₁ which is lower than the refractive index n₀ of the light guide 2. That way, there will be TIR in the light guide 2 in both the front surface 3 and the rear surface 4, as indicated by the arrows, provided that the angle of incidence is wide enough. As an example, the optical layer 21 may be provided by means of a resin used as a cladding material for optical fibers. Such a resin lay may be provided on the light guide 2 before assembly with the LCD unit 6. Also, optical adhesives are readily available in the market with various refractive indices, and can be used as the optical layer 21 for adhering the light guide 2 to the LCD unit 6. Another example of an optical layer 21 with a lower refractive index is an air gap 21, as will be described further below. In another embodiment, the optical layer 21 is a wavelength-dependent reflector. Particularly, reflection of the emitter light in the rear surface 4 is obtained by providing an optical layer 21 which is at least partly reflective for the emitter light, while at the same time being highly transmissive for visible light. As an example, such an optical layer 21 may be provided by means of a commercially available coating called IR Blocker 90 by JDSU. This coating 21 has a reflectivity of up to 90% in the NIR, while at the same time being designed to minimize the effect on light in the visible (VIS) range to not degrade the display performance of the touch system, and offers a transmission of more than 95% in the VIS. It should be noted that there are also other usable available types of coatings, IR Blocker 90 being mentioned merely as an example. This type of wavelength-dependent reflectors are typically formed by means of multi-layer coatings, as is well known in the art. In an embodiment of this kind, light from the emitters 7 will propagate by TIR in the front surface 3 and by partial specular reflection in the rear surface 4.

FIG. 14 also indicates an element 21a at the rear surface of the light guide 2, in the peripheral region 11, which constitutes an extension portion 21a to the optical layer 21. The extension portion 21a preferably has a thickness that is substantially the same as the thickness as the optical layer 21. In one embodiment, the extension portion 21a has a refractive index n₂ which is higher than the refractive index n₁ of the optical layer 21. This way, light that is injected into the light guide 2 through the extension portion 21a may still be reflected in the rear surface 4 where it faces the optical layer 21, provided that the angle of incidence is large enough. The refractive index n₂ of the extension portion 21a may e.g. be the same as the refractive index n₀ for the light guide 2. Alternatively, a material for the extension portion 21a may be chosen such that its refractive index lies between the refractive index for the light guide 2 and the refractive index for the emitter 7 and/or the detector 8. In one embodiment the extension portion 21a may be formed by means of an optical adhesive 21a, specifically selected to have a higher refractive index n₂ than the refractive index n₁ of the optical layer 21 in the center region 12. As already indicated above, the effect of an optical layer 21 may alternatively be obtained by providing an air gap 21 between the image-forming pixels 10 and the light guide 2 at the central region 12, whereas the extension portion 21a provides both mechanical and optical contact in the peripheral region 11. The gap 21 may in such an embodiment be in connection with its environment or be sealed. Also, it may be filled with another gas than air. It is currently believed that an air gap of at least about 2-3 μm is sufficient to enable propagation by TIR in the light guide 2. This variant may facilitate removal and replacement of the light guide 2 in the course of service and maintenance.

The touch-sensing display panel 1 may also include structures configured to re-direct the light emitted by the emitters 7, e.g. to reshape the emitted cone of light so as to increase the amount of light coupled into the light guide 2 in a desired fashion. For example, the emitted light may be redirected so as to form the fan beam in the plane of the light guide 2, as shown in FIG. 3, and/or the emitted light may be redirected to increase the amount of light that is trapped by TIR in the light guide 2. These light-directing structures may be included in the above-mentioned extension portion 21a at least at the incoupling region 77 to the light guide 2, on or connected to the rear surface 4 facing the peripheral region 11 of the display unit 6. Similar light-directing structures 21a may be included between the light guide 2 and the detectors 8 at the outcoupling region 81, so as to re-direct outcoupled light onto the detectors 8. Generally, the light-directing structures 21a may be said to define the field of view of the emitter/detector 7, 8 inside the light guide 2. The light-directing structures 21a may be in the form of micro-structured elements, such as but not limited to, reflectors, prisms, gratings or holographic structures. The micro-structured elements may be etched, printed, hot embossed, injection molded, pressure molded or otherwise provided between the emitters/detectors 7, 8 and the light guide 2. Light-directing structures may be omitted in the extension portion 21a, whereby part of the emitted light will pass through the light guide 2 without being trapped by TIR. Selected parts of the front surface 3 of the light guide 2, e.g. above the peripheral region 11, may be provided with a coating or cover 22, as described, to prevent such light from passing the front surface 3.

Referring back to the embodiment of FIG. 10, the extension portion 21a may constitute or comprise the first QD structure 71. In such an embodiment, an optical layer 21 at the central region 12 may be an air gap or an separate sheet having lower refractive index n₁ than the refractive index n₀ of the light guide 2. Also, the embodiment of FIG. 12 may be combined in this respect, with the third QD structure 76 over the detectors 8 in the peripheral region 11. The first 71 and third 76 QD structures may in such an embodiment be configured as separate elements, e.g. separately attached to the rear surface 4 of the light guide 2, or as different portions of one common strip placed along the peripheral region 11.

FIG. 15 schematically shows an electronic device 40, comprising a touch-sensing display panel. It is to be understood that the touch-sensing display panel 1 as described above in a multitude of different embodiments, may form part of any form of electronic device 40, including but not limited to a laptop computer, an all-in-one computer, a handheld computer, a mobile terminal, a gaming console, a television set, etc. The electronic device 40 typically includes a controller 41, such as a processor or similar, that may be connected to control the LCD unit 6 for causing the pixel elements of the first selected portions 271 to open in a predetermined pattern, so as to emulate the light emitters 7 of the touch-sensing display panel display panel 1. In one embodiment, the controller 41 of the electronic device 40 is configured to cause the pixel elements in the first selected portions 271 to open in succession such that said emitters will act as flashed one by one. This way, the electronic device 40 is configured to display information content within at least part of the touch surface 3 and to provide touch sensitivity within the touch surface 3.

While the invention has been described in connection with what is presently considered to be the most practical and preferred embodiments, it is to be understood that the invention is not limited to the disclosed embodiments, but on the contrary, is intended to cover various modifications and equivalent arrangements included within the scope of the appended claims. It should be noted that while certain features have been described in conjunction with different drawings, such features may well be combined in one and the same embodiment.

1. A touch-sensing display panel, comprising:
a liquid crystal display (“LCD”) unit including a backlight unit and a plurality of image-forming pixel elements arranged in a central region;
a light emitter comprising a pixel element of a first selected portion of a peripheral region of the LCD unit, said light emitter including a first quantum dot structure configured to receive excitation light from said backlight unit and emit light at a wavelength longer than said excitation light through the pixel element;
a planar light guide comprising a front surface forming a touch-sensing region and an opposite rear surface facing the LCD unit, said planar light guide configured to receive the emitted light from the light emitter for propagation in the planar light guide through total internal reflection; and
a light detector configured to receive light from the planar light guide.

2. The touch-sensing display panel of claim 1, wherein said first quantum dot structure is configured to emit light in the IR range upon excitation by light in the visible range.

3. The touch-sensing display panel of claim 1, wherein said first quantum dot structure is arranged in a layer disposed between the backlight unit and the pixel elements in the peripheral region or between the rear surface of the planar light guide and the pixel elements in the peripheral region.

4.-5. (canceled)

6. The touch-sensing display panel of claim 1, comprising a second quantum dot structure configured to emit light in the visible region upon excitation by light from a backlight light source of said backlight unit.

7. The touch-sensing display panel of claim 6, wherein said second quantum dot structure is arranged in a layer disposed between the backlight unit and the pixel elements in the central region.

8. The touch-sensing display panel of 6, wherein the first quantum dot structure is arranged outwardly of the second quantum dot structure, at least partly in a common layer.

9. The touch-sensing display panel of claim 8, wherein the first quantum dot structure and the second quantum dot structure are formed as different portions of a common sheet.

10. The touch-sensing display panel of claim 6, wherein said second quantum dot structure is arranged in a layer disposed between the backlight unit and the pixel elements in the central region and in the peripheral region.

11. The touch-sensing display panel of claim 6, wherein said second quantum dot structure is configured to emit light in the green and red region upon excitation by blue light from said backlight light source.

12. The touch-sensing display panel of claim 1, comprising:
an optical layer disposed at the rear surface of the light guide over at least the central region of the panel, wherein said optical layer is configured to reflect at least a part of the light from the emitter impinging thereon from within the light guide.

13. The touch-sensing display panel of claim 12, wherein said light guide has a first refractive index and the optical layer has a second refractive index which is lower than the first refractive index.

14. The touch-sensing display panel of claim 12, wherein said optical layer is an air gap.

15. The touch-sensing display panel of claim 12, wherein said optical layer is an optical coating, sheet or adhesive.

16. The touch-sensing display panel of claim 13, wherein an extension portion to the optical layer is disposed over the light emitter, said extension portion having a third refractive index which is higher than the second refractive index.

17. The touch-sensing display panel of claim 12, wherein said first quantum dot structure is provided in the peripheral region as an extension portion to said optical layer in the central region.

18. The touch-sensing display panel of claim 12, wherein the light emitter is coupled to emit light into the light guide, which light bypasses said optical layer.

19. The touch-sensing display panel of claim 12, wherein said light detector is coupled to receive light from the light guide, which light bypasses said optical layer.

20. The touch-sensing display panel of claim 1, wherein said LCD unit comprises a TFT electrode layer, to which said light detector is connected.

21. The touch-sensing display panel of claim 1, wherein a pixel element of a second selected portion of the peripheral region is configured to pass light to said light detector.

22. The touch-sensing display panel of claim 1, comprising a plurality of emitters and/or detectors wherein a grid of propagation paths is defined across the touch-sensing region between pairs of light emitters and light detectors.

23.-25. (canceled)
